(19) United States
(12) Patent Application Publication
(10) Pub. No.: US 2015/0100392 A1
(43) Pub. Date: Apr. 9, 2015

(54) Dynamic Ballots for Voting

(71) Applicant: TopwHats Inc., San Diego, CA (US)

(72) Inventor: Ephraim Feig, San Diego, CA (US)

(73) Assignee: TopwHats Inc., San Diego, CA (US)

(21) Appl. No.: 14/049,768

(22) Filed: Oct. 9, 2013

(51) Int. Cl. G07C 13/00

(52) U.S. Cl. CPC G07C 13/00
USPC 705/12

(57) ABSTRACT

A system and method for voting is disclosed. The system and method allows voters to vote for write-in candidates, and then updates the ballot so that the written-in candidates appear as listed candidates alongside the other listed candidates on the ballot. The disclosed system and method reduces the inherent disadvantage of write-in candidates in current voting systems and methods.

### FIELD OF INVENTION

The invention relates to systems and methods for voting. More particularly the invention relates to a system and method for voting with write-in option in which the ballot evolves dynamically, so that once a voter submits a write-in candidate, an updated ballot is presented to subsequent voters, which includes the name of the write-in candidate.

### BACKGROUND OF THE INVENTION

Systems and methods for voting have been described since days of antiquity. For a typical system and method, some entity initiates a poll utilizing a ballot, such ballot comprising one or numerous ballot items, each such ballot item comprising a ballot question and one or more candidate answers to that question, with mechanisms to allow voters to identify one or several answers to each question and then transmit this information to some entity for processing.

The term poll is used here in a very general sense. It may be an election, a survey, a referendum, or any other application in which people are asked to choose one or several options from a collection of options related to a set of issues.

The terms “ballot question” and “candidate answers” are very general. For example, a ballot question may be the phase “President of Club A,” which corresponds to the question “Who are you voting for President of Club A?” and in which case candidate answers would presumably be names of people. Or, a ballot question may be “Best movie of 2012,” in which case candidate answers would presumably be names of movies. In what follows, we will use the terms “candidates” and “candidate answers” interchangeably.

The types of entities that may initiate a poll are numerous. With the advent of the Internet and modern web-based technologies, systems exist that allow any computer user to initiate a poll. Numerous online services enable such capabilities, including www.surverymonkey.com, www.pollcode.com, and www.micropoll.com.

Sometimes a poll will allow write-in candidates. In such a case, a ballot item has one or numerous candidates presented for voting plus a place in the ballot item where a voter may write in a candidate that does not appear on the ballot item, and this write-in candidate will be be considered in the final tally of votes along with the other candidates.

In polls with write-in options, candidates who are written-in are at a distinct disadvantage. Voters who cast their votes after the write-in do not necessarily know about the new entrant in the poll and are therefore less likely to vote for this written-in candidate. The present invention reduces this disadvantage by having all subsequent voters see the new candidate alongside the other candidates as just another candidate on the ballot.

### SUMMARY OF THE INVENTION

A system and method for voting provide write-in options such that after a voter submits a write-in candidate, that new candidate appears on the ballot as a listed candidate for all subsequent voters to see. The system includes a database to store votes and other information related to the poll, and a computer program to generate new ballots that incorporate write-in candidates as they are introduced.

### BRIEF DESCRIPTION OF THE DRAWINGS

FIG. 1 illustrates a networked environment for an embodiment of the present invention.

FIG. 2 illustrates a ballot with one question, two candidates and a write-in option.

FIG. 3 illustrates what a user sees after having selected to enter a write-in candidate.

FIG. 4 illustrates a user interface containing a text-input box for submitting a write-in candidate.

FIG. 5 illustrates what a user sees after typing in the name of a write-in candidate in the text-input box, before clicking the Enter button.

FIG. 6 illustrates a ballot that was initiated with two candidates and then updated with a third candidate that received a write-in vote.

FIG. 7 illustrates an authoring tool containing two text-input boxes for initiating a poll with one question and one candidate.

FIG. 8 illustrates what a user sees after typing in a ballot question and a candidate into the text-input boxes of the authoring tool, before clicking the Enter button.

FIG. 9 illustrates the newly initiated ballot with one question, one candidate and a write-in option, before any new write-in candidates have been added to the ballot.

### DETAILED DESCRIPTION OF THE INVENTION

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalents.

A poll is conducted online. Referring to FIG. 1, Database 101 stores all the data related to the poll. This includes, but is not limited to, questions, candidates, identifiers of eligible voters, tallies of votes and who has already voted, and a time when voting ends, if such a time is desired. The Database may comprise one or numerous computers and may reside in one or numerous geographical areas. Server 102 contains a computer program for processing data from the database and from devices into which users input information, including a program to generate and update ballots. The program also handles all communication with devices across Network 103 and with the Database. The Server may comprise one or numerous computers and may reside in one or numerous geographical areas. The Network may be the Internet, or any other network. Devices 104 are any computerized hardware that can display ballots generated by the program in the Server and communicate back to the server responses to the questions in the ballot. Such devices include, but are not limited to, desktop computers, laptop computers, and mobile devices such as notepads and smart-phones. The devices are all labeled 104 because, functionally, in terms of executing the invention, they all behave the same, even if the display of ballots may vary according to the sizes of the screens of the various devices.

In a preferred embodiment, the poll is executed inside a controlled environment, a website where users can register and then log in to identify themselves. Once a user has signed in, the Server maintains the identity of that user for the duration of the session, so that all interactions with the system during the session are attributable to that user.

The website has a page with a poll. The poll utilizes a ballot with one question, one or more candidates and a write-in option. If the user has not yet voted in this poll, then the system will allow this user to vote in this poll.

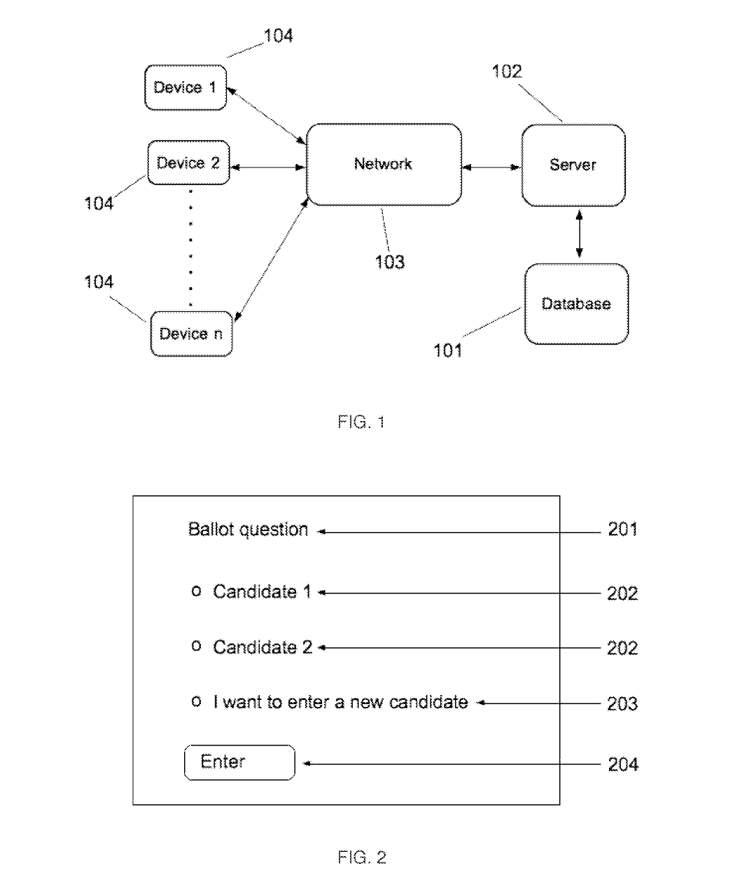

FIG. 2 illustrates a ballot for this poll, in which two candidates are listed. This ballot appears as a portion of a screen on a device that a user sees when accessing the poll. Ballot question 201 is text on a screen, describing what registered users will be voting on.

Items 202 and 203 form a set of radio-buttons. A radio-button is text on a screen and an actionable element on the screen next to the text, so that when a user puts a cursor on this element and clicks it or touches the element if the screen is touch sensitive, then the element gets highlighted. Throughout the rest of the description, the term “click” an element will mean either “put a cursor on it and click it” or “touch it, if it is a touch sensitive screen.” A set of radio-buttons is a collection of radio-buttons in which at most one of them can be highlighted at any time. Accompanying the set of radio-buttons is Enter button 204. Upon clicking the Enter button, the device sends information via the Network to the Server, where the computer program processes this information and then takes action according to which selection was made.

The text of items 202 are candidates for Ballot question 201. Even though the names are different in the two radio-buttons 202, both radio buttons are functionally identical, hence the identical labels. If a user wants to vote fro any candidate 202, he would highlight the corresponding actionable element and then click Enter button 204. The Device communicates the selection back to the Server via the Network, where the computer program acts according to the selection made. The program finds the portion of the Database containing the selected candidate, adds one to the tally of votes fro that candidate, and records that the user has cast a vote for this ballot.

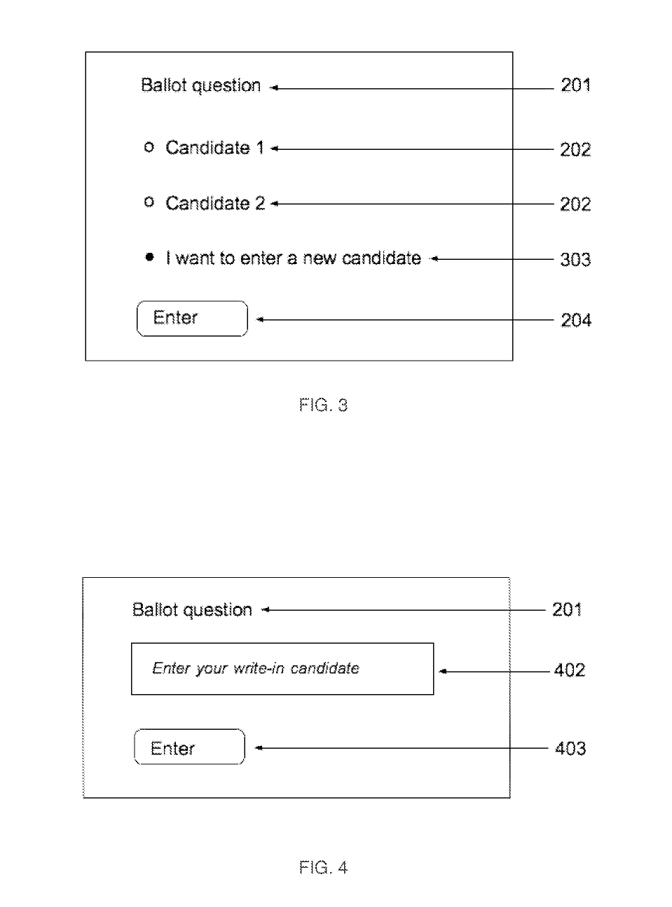

If a user wants to enter a new candidate via the write-in option, he would highlight the actionable element of radio-button 203 next to the text “I want to enter a new candidate.” FIG. 3 illustrates what the user would then see on a screen after highlighting the actionable element in 203. The status of this radio-button has changed, and the user now sees 303. The Enter button in FIG. 3 is still labeled 204 because functionally, it is identical to the Enter button in FIG. 2. As before, if the user clicks Enter button 204, the Device communicates the selection back to the Server via the Network, where the computer program acts according to the selection made. In this case, the computer program in the Server sends a message to the Device to exhibit on a portion of the screen a display such as illustrated in FIG. 4. Ballot question 201 is again displayed. Also displayed is text-input box 402. A text-input box is a display area into which a user can type text. Often, as is the case in this embodiment, a text-input box is first displayed with placeholder text. This is text that is in the box, typically of a different color or thin from the regular typed-in text, and which disappears as soon as a user gaits entering text into the box. The placeholder text typically provides some instruction or clue to the user, guiding him on how to proceed.

If the user clicks Enter button 403 before entering any text in the text-input box, the device transmits information back to the Server indicating the empty text field, and the Server returns to the device a signal to display a message that the empty vote is not valid.

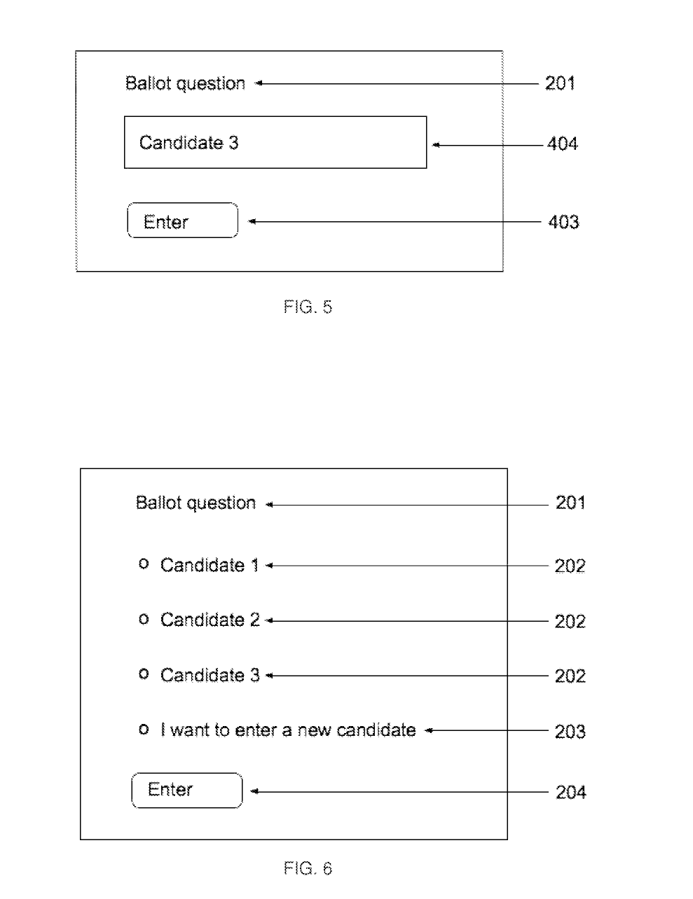

If the user enters a candidate in the text-input box, the box changes status. FIG. 5 illustrates what the user would see after entering “Candidate 3” into the text-input box. The typed text would appear in box 404. If the user then clicks Enter button 403, the device would transmit to the Server the information in the text-input box. The program in the Server generates a new entry in the poll, namely the candidate that was written in, allocates one vote to it and records that the user has cast a vote for this ballot. It then updates the ballot for the poll so that the new candidate appears as one of listed candidates on the ballot.

FIG. 6 illustrates what a user would see after the system generated the new ballot with the third candidate in the list. The elements in FIG. 6 are functionally identical to the elements in FIG. 2. The difference between the two figures is the number of listed candidates 202. In FIG. 6, the written-in candidate has been added to the roster. Because the elements are functionally identical, the process can proceed indefinitely according to the teachings of the previous paragraphs or until some criteria is reached wherein the program stops the process. One such criteria may be a time limit for voting.

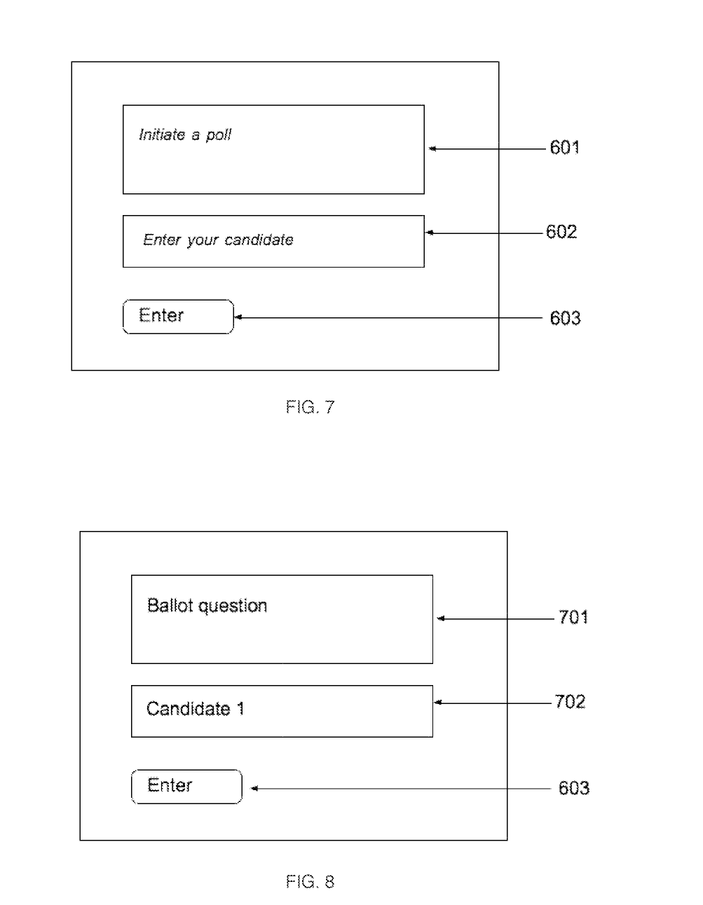

In one embodiment, the system allows any registered user to initiate a poll. In one such particular embodiment, a user may initiate a poll with one question and one candidate. The system provides an authoring tool to the user in order to initiate this poll. FIG. 7 illustrates a view of such an authoring tool. Text-input box 601 is for the user to enter the ballot question. Text-input box 602 is for the user to enter a candidate. Enter button 603 is to signal the Device to transmit the information entered in 601 and 602 to the Server, which then processes it. If the user clicks 603 when either text-input boxers empty, the Server will return an error message.

FIG. 8 illustrates a view of the authoring tool after a user enters text into both text-input boxes. Both boxes now change status, 701 contains the text for the ballot question in the poll that the user wants to initiate, and 702 contains the candidate for which the user wants to cast a vote. When the user then clicks Enter button 603, the device transmits the information in the text-input boxes to the Server. The program in the server then creates a new poll, sets up the necessary tables in the database to store data for this poll, builds an initial ballot for the poll, records one vote for the initial candidate and that the user has cast a vote for this ballot, and sends this ballot to Devices that request it.

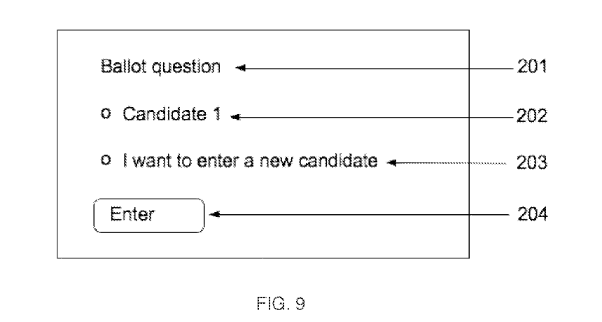

FIG. 9 illustrates the ballot for this newly initiated poll. The elements in this ballot are functionally identical to those in FIG. 2, and therefore the teaching of the previous paragraphs show that the voting process can proceed indefinitely or until some criteria is reached wherein the program stops the process.

The disclosed embodiments are illustrative, not restrictive. One can create numerous alternate embodiments and extensions of the general invention of dynamic ballots. Below are examples, certainly not exhaustive, of possible variations.

In one embodiment, the website displays the tally of votes in real time, even while the poll is active.

In one embodiment, voters who have already voted have the option of returning to the ballot and changing their vote, as long as the poll is active.

The ballot need not be accessed via the Internet. The entire system could be contained in a single personal computer.

The size of the list of candidates may be subject to a limit according to some rule. The rule may be that when the limit is reached, the write-in option disappears. Or, the rule may be that after the limit has been reached, when a new write-in candidate is proposed, the listed candidate with the least number of votes is dropped and replaced by the new write-in candidate. Other rules may be instituted.

A website may host numerous polls and allow visitors to see all polls, whether active or ended. A registered user who is logged in can click on a link to an active poll that will take him to this poll. If this user has already voted in this poll, upon clicking the link, a message will be displayed that the user has already voted in this poll. If the user has not yet voted in this poll, then upon clicking the link, a ballot will be displayed.

A ballot may have numerous questions.

A ballot may have some questions with write-in options and some without.

A poll may allow the selection of more than one candidate for some ballot questions.

A poll may allow the submission of an empty text-input box entry.

1. A voting system for facilitating live interactive voting, comprising:
a database to store one or more ballots, at least one ballot having a question with at least one listed candidate and a write-in option;
a server to serve the ballots over a network to users;
a database to store registered voters and ballot information and to record which voters have voted and the voting results;
a computer program that, immediately after a write-in candidate has been submitted as a vote on a question in a ballot, updates that ballot so that the new ballot contains the written-in candidate as another listed candidate for that question.

2. A voting system as cited in claim 1, wherein the network is the Internet.

3. A voting system as cited in claim 1, containing an authoring tool which any registered user can use to initiate a poll.

4. A voting system as cited in claim 1, wherein the initial ballot contains one question with one listed candidate and a write-in option.

5. A voting system as cited in claim 1, wherein real time tally of votes is available to users.

6. A voting system as cited in claim 1, wherein one who has already voted can change his or her vote.

7. A voting system for facilitating live interactive voting, comprising:
a database to store one or more ballots, at least one ballot having a question with at least one listed candidate, a maximum number of allowed listed candidates, and a write-in option;
a server to serve the ballots over a network to users;
a database to store registered voters and ballot information and to record which voters have voted and the voting results;
a computer program that, immediately after write-in candidate has been submitted as a vote for a question on a ballot, if the maximum number of allowed listed candidates for that question has not yet been reached, updates the ballot so that the new ballot contains the written-in candidate as another listed candidate for that question.

8. A voting system as cited in claim 7, wherein the write-in option for a question disappears after the maximum number of allowed listed candidates for that question is reached.

9. A voting system as cited in claim 7, wherein immediately after a write-in candidate has been submitted as a vote for a question on the ballot, if the maximum number of allowed listed candidates has been previously reached, updates the ballot by dropping one of the previously listed candidates and adding the newly written-in candidate to the list.

10. A voting system as cited in claim 7, wherein the network is the Internet.

11. A voting system as cited in claim 7, containing an authoring tool which any registered user can use to initiate a poll.

12. A voting system as cited in claim 7, wherein the initial ballot contains one question with one listed candidate and a write-in option.

13. A voting system as cited in claim 7, wherein real time tally of the votes is available to users.

14. A voting system as cited in claim 7, wherein one who has already voted can change his or her vote.

15. A method of voting with write-in option, wherein once a write-in candidate has been submitted, that candidate appears alongside previously listed candidates in future ballots.

16. The method of claim 15, wherein there is a limit on the total number of candidates in a ballot and a rule for managing the list of candidates so as to maintain that limit.

17. The method of claim 15, wherein any registered voter may initiate a poll.

18. The method of claim 15, wherein real time tally of votes is available to voters.

19. The method of claim 15, wherein one who had already voted can change his or her vote.
